(19) United States
(12) Patent Application Publication
(10) Pub. No.: US 2023/0300889 A1
(43) Pub. Date: Sep. 21, 2023

(54) DATA TRANSMISSION IN RACH PROCEDURES

(71) Applicant: QUALCOMM Incorporated, San Diego, CA (US)

(72) Inventors: Ruiming ZHENG, Beijing (CN); Ozcan OZTURK, San Diego, CA (US); Umesh PHUYAL, San Diego, CA (US); Linhai HE, San Diego, CA (US); Jing LEI, San Diego, CA (US); Miguel GRIOT, La Jolla, CA (US); Gavin Bernard HORN, La Jolla, CA (US)

(21) Appl. No.: 18/009,253

(22) PCT Filed: Jul. 29, 2020
(86) PCT No.: PCT/CN2020/105577

§ 371 Date: Dec. 8, 2022

(51) Int. Cl. H04W 74/08; H04W 76/20; H04L 1/1812

(52) U.S. Cl. CPC H04W 74/0833; H04W 76/20; H04L 1/1812

(57) ABSTRACT

The present disclosure relates to methods and devices for wireless communication including an apparatus, e.g., a user equipment (UE) and/or base station. In one aspect, the apparatus can determine to enter into a two-step RACH procedure in an RRC inactive state. The apparatus can also determine to transmit uplink data in a payload of a message A (MsgA) of the two-step RACH procedure. The apparatus can also transmit the MsgA of the two-step RACH procedure, the MsgA including the payload, the payload including at least the uplink data. Additionally, the apparatus can monitor for a MsgB of the two-step RACH procedure. The apparatus can also receive the MsgB of the two-step RACH procedure, where the MsgB includes a fallback indication including a fallback RAR. Further, the apparatus can retransmit the payload of the MsgA when the MsgB including the fallback indication is received.

### BACKGROUND

### Technical Field

The present disclosure relates generally to communication systems, and more particularly, to random access channel (RACH) procedures in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive an instruction to enter into the RRC inactive state from a base station. The apparatus may also determine to enter into a two-step random access channel (RACH) procedure in a radio resource control (RRC) inactive state. The apparatus may also determine to transmit uplink data in a payload of a message A (MsgA) of the two-step RACH procedure. Additionally, the apparatus may transmit the MsgA of the two-step RACH procedure, the MsgA including the payload, the payload including at least the uplink data. The apparatus may also monitor for a message B (MsgB) of the two-step RACH procedure. The apparatus may also receive the MsgB of the two-step RACH procedure, where the MsgB includes a fallback indication including a fallback random access response (RAR). Further, the apparatus may retransmit the payload of the MsgA when the MsgB including the fallback indication is received. The apparatus may also transmit a message 3 (Msg3) after the MsgB including the fallback indication is received, wherein a hybrid automatic repeat request (HARM) retransmission is applied for the Msg3. The apparatus may also monitor for a message 4 (Msg4) after the Msg3 is transmitted. Moreover, the apparatus may receive the Msg4, where the Msg4 includes at least one of a preconfigured uplink resource (PUR) or downlink data. The apparatus may also store the uplink data in at least one buffer, where a payload of a retransmitted MsgA or a retransmitted payload of the MsgA includes at least one of an RRC message or a data request message. The apparatus may also retransmit the MsgA when the MsgB or a Msg4 is not received, the retransmitted MsgA including a payload and a preamble, where the retransmitted MsgA includes at least one of an RRC message or a data request message. The apparatus may also switch from the two-step RACH procedure to a four-step RACH procedure when the MsgA is retransmitted at least a configured threshold number of retransmissions. The apparatus may also select one or more preamble groups of the four-step RACH procedure, where a transport block (TB) size of each of the one or more preamble groups of the four-step RACH procedure is different from a TB size of each of one or more preamble groups of the two-step RACH.

In another aspect of the disclosure, a method, a computer-readable medium, and an apparatus are provided. The apparatus may be a base station. The apparatus may transmit, to at least one user equipment (UE), an instruction to enter into a radio resource control (RRC) inactive state. The apparatus may also receive a message A (MsgA) of a two-step random access channel (RACH) procedure, the MsgA including a payload, the payload including at least uplink data. The apparatus may also receive a retransmitted payload of the MsgA when the MsgB including the fallback indication is transmitted. Additionally, the apparatus may transmit a message B (MsgB) of the two-step RACH procedure. The apparatus may also receive a message 3 (Msg3) after the MsgB including the fallback indication is transmitted, wherein a hybrid automatic repeat request (HARM) retransmission is applied for the Msg3. The apparatus may also transmit a message 4 (Msg4), where the Msg4 includes at least one of a preconfigured uplink resource (PUR) or downlink data. The apparatus may also receive a retransmitted MsgA including a payload and a preamble, where the retransmitted MsgA includes at least one of an RRC message or a data request message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating example communication between a UE and a base station in accordance with one or more techniques of the present disclosure.

FIG. 5 is a diagram illustrating example communication between a UE and a base station in accordance with one or more techniques of the present disclosure.

FIG. 6 is a diagram illustrating example communication between a UE and a base station in accordance with one or more techniques of the present disclosure.

FIG. 7 is a diagram illustrating example communication between a UE and a base station in accordance with one or more techniques of the present disclosure.

FIG. 8 is a diagram illustrating example communication between a UE and a base station in accordance with one or more techniques of the present disclosure.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

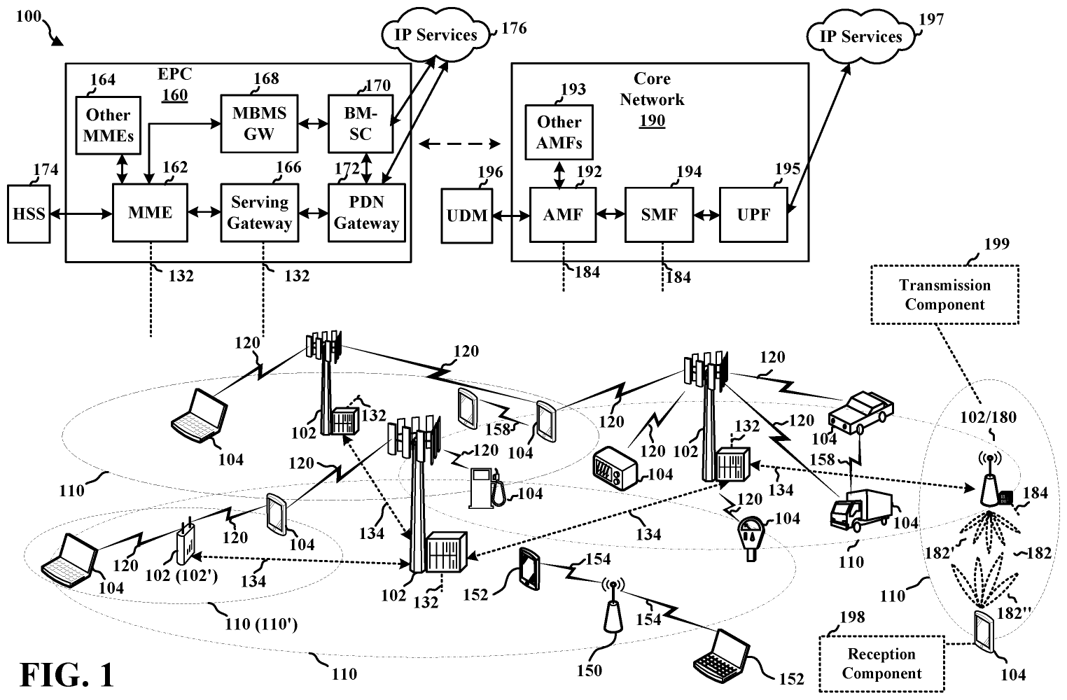

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a reception component 198 configured to receive an instruction to enter into the RRC inactive state from a base station. Reception component 198 may also be configured to determine to enter into a two-step random access channel (RACH) procedure in a radio resource control (RRC) inactive state. Reception component 198 may also be configured to determine to transmit uplink data in a payload of a message A (MsgA) of the two-step RACH procedure. Reception component 198 may also be configured to transmit the MsgA of the two-step RACH procedure, the MsgA including the payload, the payload including at least the uplink data. Reception component 198 may also be configured to monitor for a message B (MsgB) of the two-step RACH procedure. Reception component 198 may also be configured to receive the MsgB of the two-step RACH procedure, where the MsgB includes a fallback indication including a fallback random access response (RAR). Reception component 198 may also be configured to retransmit the payload of the MsgA when the MsgB including the fallback indication is received. Reception component 198 may also be configured to transmit a message 3 (Msg3) after the MsgB including the fallback indication is received, wherein a hybrid automatic repeat request (HARM) retransmission is applied for the Msg3. Reception component 198 may also be configured to monitor for a message 4 (Msg4) after the Msg3 is transmitted. Reception component 198 may also be configured to receive the Msg4, where the Msg4 includes at least one of a preconfigured uplink resource (PUR) or downlink data. Reception component 198 may also be configured to store the uplink data in at least one buffer, where a payload of a retransmitted MsgA or a retransmitted payload of the MsgA includes at least one of an RRC message or a data request message. Reception component 198 may also be configured to retransmit the MsgA when the MsgB or a Msg4 is not received, the retransmitted MsgA including a payload and a preamble, where the retransmitted MsgA includes at least one of an RRC message or a data request message. Reception component 198 may also be configured to switch from the two-step RACH procedure to a four-step RACH procedure when the MsgA is retransmitted at least a configured threshold number of retransmissions. Reception component 198 may also be configured to select one or more preamble groups of the four-step RACH procedure, where a transport block (TB) size of each of the one or more preamble groups of the four-step RACH procedure is different from a TB size of each of one or more preamble groups of the two-step RACH.

Referring again to FIG. 1, in certain aspects, the base station 180 may include a transmission component 199 configured to transmit, to at least one user equipment (UE), an instruction to enter into a radio resource control (RRC) inactive state. Transmission component 199 may also be configured to receive a message A (MsgA) of a two-step random access channel (RACH) procedure, the MsgA including a payload, the payload including at least uplink data. Transmission component 199 may also be configured to receive a retransmitted payload of the MsgA when the MsgB including the fallback indication is transmitted. Transmission component 199 may also be configured to transmit a message B (MsgB) of the two-step RACH procedure. Transmission component 199 may also be configured to receive a message 3 (Msg3) after the MsgB including the fallback indication is transmitted, wherein a hybrid automatic repeat request (HARM) retransmission is applied for the Msg3. Transmission component 199 may also be configured to transmit a message 4 (Msg4), where the Msg4 includes at least one of a preconfigured uplink resource (PUR) or downlink data. Transmission component 199 may also be configured to receive a retransmitted MsgA including a payload and a preamble, where the retransmitted MsgA includes at least one of an RRC message or a data request message.

Although the following description may be focused on 5G NR, the concepts described herein may be applicable to other similar areas, such as LTE, LTE-A, CDMA, GSM, and other wireless technologies.

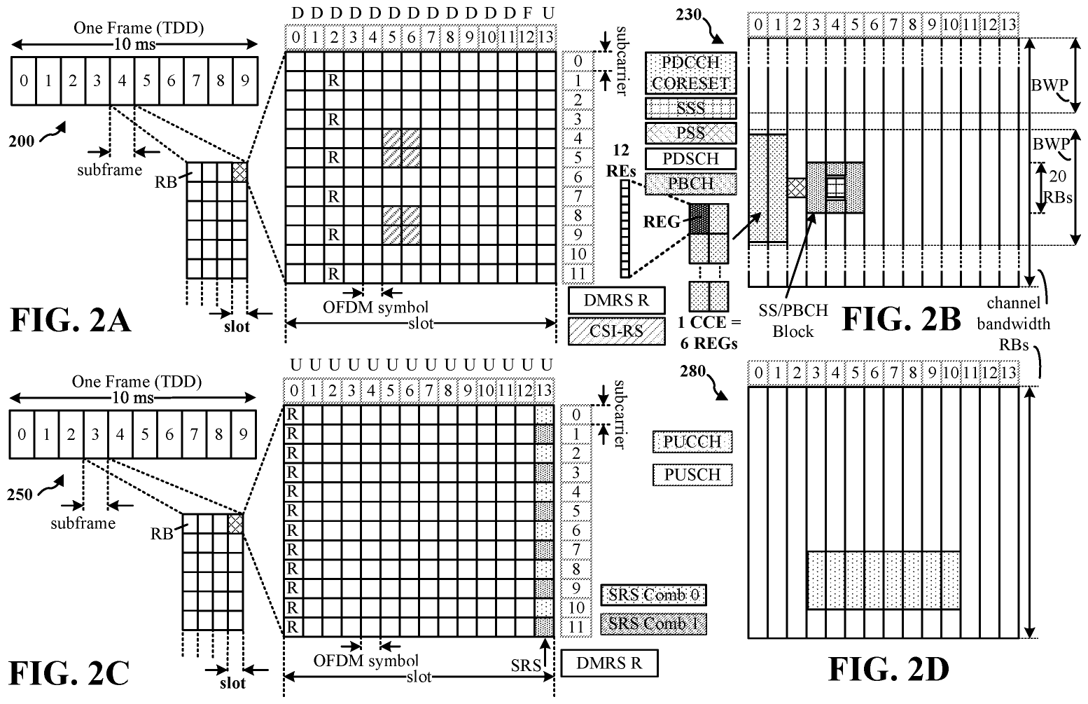

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

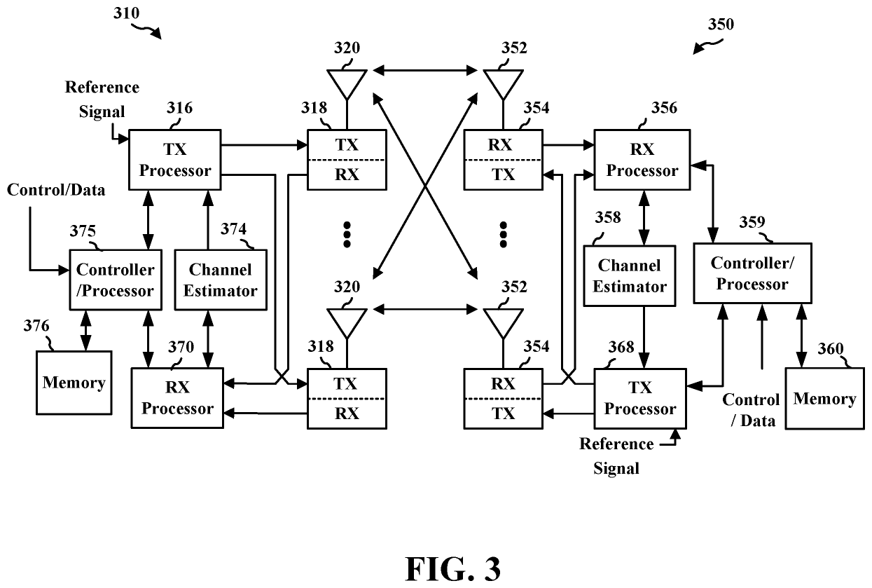

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

Some aspects of wireless communications include data transmissions for different states of a user equipment (UE), e.g., a radio resource control (RRC) inactive (RRC_INACTIVE) state. In some aspects, a UE may generate a small amount of data, i.e., small data, across a burst in a data session. This type of traffic may be applicable across each vertical including mobile broadband (MBB) and internet of things (IoT), such as instant messing software, social media software, and/or wearable IOT devices. In some instances, a network or base station may allow the UE to transmit uplink data in the RRC_INACTIVE state without the UE having to transition to an RRC connected (RRC_CONNECTED) state. The network or base station may also include a number of objectives for the data transmission. For example, uplink (UL) small data transmissions (SDT) for random access channel (RACH) based schemes, i.e., a two-step (2-step) or a four-step (4-step) RACH, can correspond to an RRC_INACTIVE state.

In some aspects, the UE can receive an instruction to enter the RRC inactive state. The UE may then determine to enter into a RACH procedure in the RRC inactive state. So the UE may transmit a small amount of data, i.e., small data, in a RACH procedure in the RRC inactive state. The base station can also instruct the UE to transition to an RRC connected state based on the communication during the RRC inactive state. This can also be included in an RRC release message from the base station.

In data transmissions during a 2-step RACH, a UE can select a preamble configured for data, e.g., mobile originated (MO) data, during the 2-step RACH. For instance, a small amount of data can be transmitted in a message A (MsgA) together with an RRC message. In some instances, this can occur if the UL grant of MsgA is large enough to handle the data. MsgA can include a preamble, user data, uplink data, e.g., PUSCH data, and an RRC message (i.e., RRCResumeRequest message). The downlink (DL) data or response data for an application acknowledgement (ACK) in response to the UL data can be scheduled in a message B (MsgB) together with the RRC message (i.e., RRCRelease message).

MsgA of the 2-step RACH procedure can include a random access (RA) preamble on a physical RACH (PRACH) and a payload on a PUSCH. After the MsgA transmission, the UE can monitor for a response (e.g., MsgB) from the network within a configured window. If network decodes the preamble successfully, but fails to decode the payload of MsgA, the network can send a fallback indication, i.e., a fallback random access response (RAR), in a MsgB. In some aspects, the payload of MsgA may not be able to be decoded due to the payload size. The MsgB can instruct the UE to transmit a message 3 (Msg3) to retransmit the MsgA payload and further monitor the contention resolution in a message 4 (Msg4). The aforementioned procedure can be referred to as a fallback procedure.

In some instances, the preamble index in a medium access control (MAC) header or MAC subheader of the fallback RAR can identify whether the MsgB corresponds to a certain UE. The network can send a fallback indication (i.e., fallbackRAR) in MsgB to guide a UE to perform Msg3 to retransmit the MsgA payload and further monitor contention resolution in Msg4. For example, if the contention resolution is not successful after a number of Msg3 transmissions, the UE may retransmit MsgA. Also, if the network does not decode either the preamble or the payload of MsgA and the UE does not receive any response within a configured time window, the UE may retransmit MsgA.

If the random access procedure with a 2-step RACH is not completed after a number of MsgA transmissions, i.e., a MsgA transmission maximum (msgA-TransMax), the UE can be configured to switch the RA procedure. For example, after a number of MsgA transmissions, the UE can switch to a 4-step contention based random access (CBRA) procedure. This 4-step CBRA can include a first message (Msg1) to be transmitted from the UE.

Based on the above, there is a present need for improved data transmission solutions during RA procedures in an RRC inactive state. During a 2-step RACH procedure when a UE is in an RRC inactive state, there is a need to perform small data transmissions in fallback procedures or MsgA retransmission procedures. For instance, there is a present need to define UE behavior in response to a fallback procedure during a 2-step RACH.

Aspects of the present disclosure can include small data transmissions during RA procedures, e.g., in an RRC inactive state. In some aspects, during a 2-step RACH procedure when a UE is in an RRC inactive state, aspects of the present disclosure can perform small data transmissions in fallback procedures or MsgA retransmission procedures. For instance, the present disclosure can define UE behavior, e.g., data transmissions, in response to a fallback procedure during a RACH procedure, e.g., a 2-step RACH.

In some aspects, the present disclosure can include a 2-step RACH fallback procedure. If the network sends a fallback indication, i.e., a fallback RAR, in a MsgB, the UE may retransmit the payload of MsgA in a message 3 (Msg3) and monitor a contention resolution in a message 4 (Msg4). The payload of MsgA may include an RRC message and user data or uplink data. In some instances, a hybrid automatic repeat request (HARD) retransmission may be allowed in a Msg3 for user data or uplink data. Also, the redundancy version (RV) may be equal to zero for a Msg3 transmission in the fallback case. Further, the TB size in an UL grant in the fallback RAR may be the same as the TB size in the payload transmission in MsgA. Also, if this is a high contention scenario, the UE may have a reduced chance to successfully transmit the data.

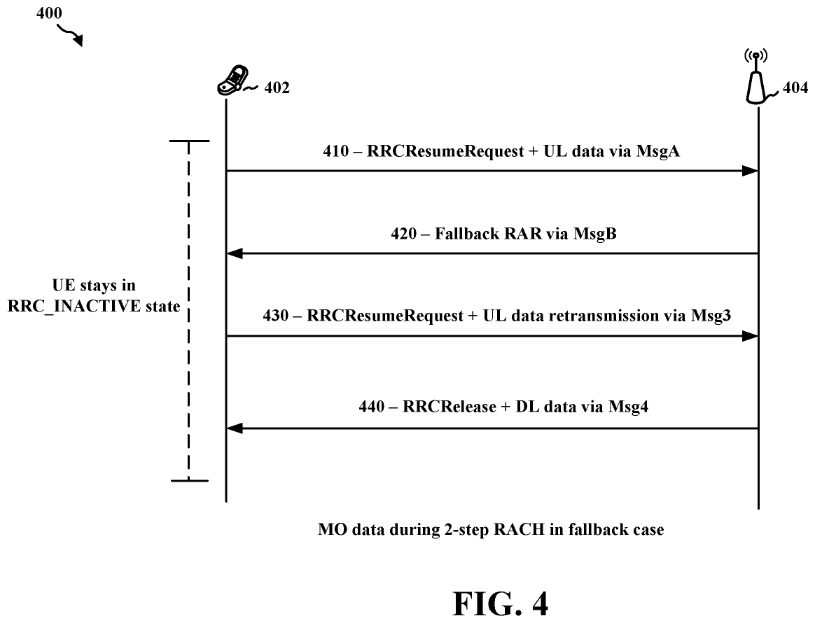

FIG. 4 is a diagram 400 illustrating example communication between a UE 402 and a base station 404 in accordance with one or more techniques of the present disclosure. As shown in FIG. 4, diagram 400 includes MO data during a 2-step RACH in a fallback case. Also, FIG. 4 displays that the UE 402 stays in an RRC_INACTIVE state for a certain amount of time.

As shown in FIG. 4, at step 410, the UE 402 can send an RRC resume request and UL data in a MsgA. The UE 402 can then monitor for a fallback RAR in a MsgB. At step 420, UE 402 can receive the fallback RAR via a MsgB from the base station 404. At step 430, the UE 402 can retransmit the payload of MsgA in Msg3, which can include the RRC resume request message and user UL data in the payload of MsgA. UE 402 can then monitor for an RRC release message and DL data in a Msg4. At step 440, the UE 402 can receive the RRC release message and DL data in the Msg4 from the base station 404.

Aspects of the present disclosure can include additional 2-step RACH fallback procedures. If the network or base station sends a fallback indication, i.e., fallback RAR, in MsgB, the UE may retransmit a portion of the payload of MsgA in Msg3 and monitor a contention resolution in Msg4. The portion of payload of MsgA can include parts of user data, if the transmitted data can be handled by UL grant. The UE can also store the entire, or a portion of, user data or UL data in a buffer, and the UE can retransmit the RRC message, i.e., RRCResumeRequest, from the original MsgA payload in Msg3. The network may respond to transition the UE to an RRC_CONNECTED state for a subsequent user data transmission. In addition, the UE can transmit an RRC message and a data request message or small data request message. The data request message may be a MAC-CE with a smaller size, i.e., compare to the original payload of MsgA, and/or an RRC message. If the network configures a preconfigured uplink resource (PUR) in Msg4, the UE can transmit a subsequent uplink packet in the preconfigured resource without entering an RRC_CONNECTED state. This can help the UE to save power.

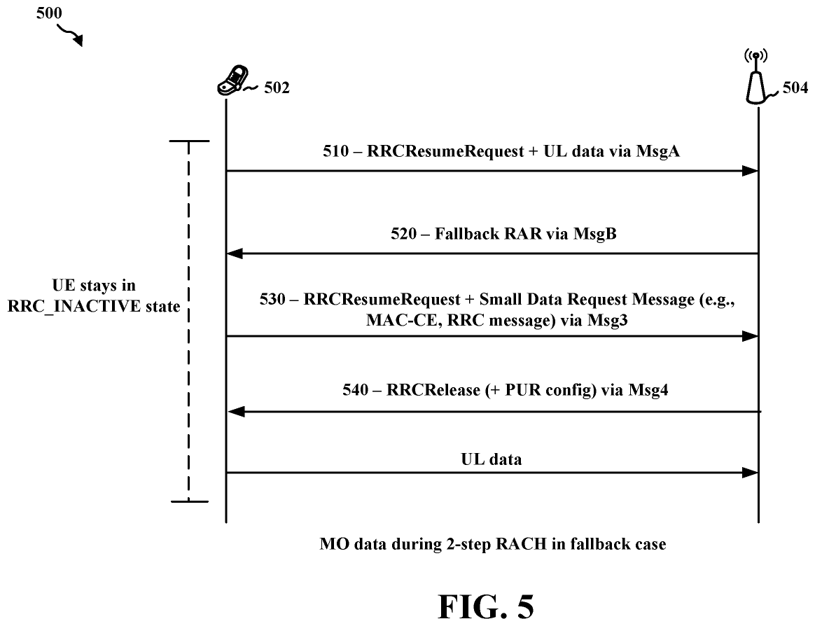

FIG. 5 is a diagram 500 illustrating example communication between a UE 502 and a base station 504 in accordance with one or more techniques of the present disclosure. As shown in FIG. 5, diagram 500 includes MO data during a 2-step RACH in a fallback case. Additionally, FIG. 5 displays that the UE 502 stays in an RRC_INACTIVE state for a certain amount of time.

As shown in FIG. 5, at step 510, the UE 502 can send an RRC resume request message and UL data in a MsgA. The UE 502 can then monitor for a fallback RAR in a MsgB. At step 520, the UE 502 can receive the fallback RAR in the MsgB from the base station 504. Also, at step 530, the UE 502 can retransmit the payload of MsgA in Msg3, which can include the RRC resume request message and a small data request message, e.g., a MAC-CE and/or updated RRC message, in Msg3. UE 502 can then monitor for an RRC release message and a preconfigured uplink resource (PUR) in a Msg4. At step 540, the UE 502 can receive the RRC release message and the PUR in Msg4 from the base station 504.

In some aspects, after a 2-step RACH fallback, if a contention resolution is not successful after a number of Msg3 transmissions, or after a MsgA transmission, the network may not decode the preamble and/or the payload of MsgA. As such, the base station may not provide a response within the configured time window. When this occurs, the UE may return to a MsgA transmission. Also, when MsgA is retransmitted, the MsgA payload may be transmitted without any modifications. The payload of MsgA may include the RRC message and user data. During retransmission, the MsgA preamble index and the preamble group may not be modified. Also, the RV may be equal to zero for a MsgA PUSCH initial transmission and MsgA retransmissions. As the first MsgA transmission may fail, and if this is a high contention scenario, the UE may have a reduced chance to successfully transmit the data in the MsgA retransmissions.

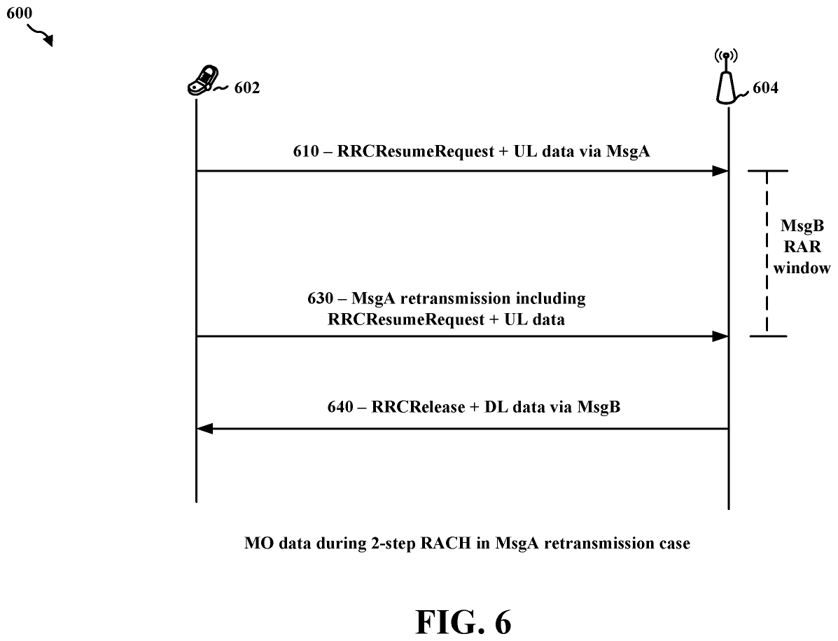

FIG. 6 is a diagram 600 illustrating example communication between a UE 602 and a base station 604 in accordance with one or more techniques of the present disclosure. As shown in FIG. 6, diagram 600 includes MO data during a 2-step RACH in a MsgA retransmission scenario. Moreover, FIG. 6 displays that diagram 600 includes a MsgB RAR window.

As shown in FIG. 6, at step 610, the UE 602 can send the RRC resume request message and UL data in a MsgA. The UE 602 can then monitor for a MsgB. If the network or base station does not provide a response within the configured window, and does not decode the preamble and/or the payload of MsgA, at step 630, the UE 602 may retransmit MsgA, which can include the RRC resume request message and UL data. The UE can then monitor for MsgB. At step 640, the UE 602 may receive MsgB including the RRC release message and DL data.

In some instances, the MsgA payload may not be modified when MsgA is retransmitted. The payload of MsgA may include the RRC message and/or user data or UL data. Also, the UE may reselect a new preamble index and/or a new preamble group for the preamble of MsgA during the MsgA retransmission. The new preamble index and/or new preamble group may map to the PUSCH resource with a larger UL grant resource. This can increase the likelihood that the UE will successfully transmit the small data or uplink data. So during the MsgA retransmission, the UE may re-select one new preamble index or one or more new preamble groups including a preamble index.

In some aspects, after a 2-step RACH fallback procedure, if a contention resolution is not successful after the Msg3 transmissions, or a MsgA transmission, the network may not respond within a configured time window, and may not decode the preamble and/or payload of MsgA. When this occurs, the UE may retransmit MsgA. When MsgA is retransmitted, the UE can store UL data or user data in a buffer, and retransmit the RRC message, i.e., RRCResumeRequest, from the original MsgA. The network may instruct the UE to transition to an RRC_CONNECTED state for subsequent user data transmissions.

As indicated herein, when MsgA is retransmitted, the UE can store user data or part of the user data in at least one buffer, and/or transmit part of the user data in MsgA. The small data request message may be a MAC-CE with a smaller size and/or an RRC message. The network may configure the preconfigured uplink resource (PUR) in MsgB, then the UE can transmit subsequent uplink data packets in the preconfigured resource without entering an RRC_CONNECTED state, which can save power at the UE. Also, the UE may reselect a new preamble index or preamble group which can map to the PUSCH resource with a larger UL grant resource.

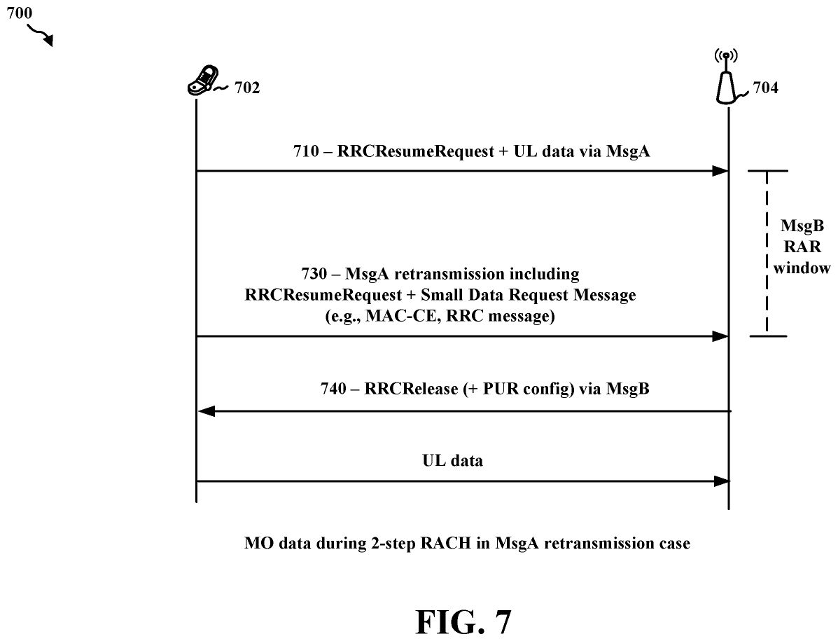

FIG. 7 is a diagram 700 illustrating example communication between a UE 702 and a base station 704 in accordance with one or more techniques of the present disclosure. As shown in FIG. 7, diagram 700 includes MO data during a 2-step RACH in a MsgA retransmission scenario. Additionally, FIG. 7 displays that diagram 700 includes a MsgB RAR window.

As shown in FIG. 7, the UE 702 can send the RRC resume request and UL data in a MsgA. The UE 702 can then monitor for a MsgB. If the network or base station does not decode the preamble and the payload of MsgA, and does not provide a response within a configured time window, e.g., a RAR window, then, at step 730, the UE 702 may retransmit MsgA. The retransmitted MsgA may include an RRC resume request message, part of a user data, and/or a data request message, e.g., a MAC-CE and an RRC message. The UE 702 can then monitor for MsgB. At step 740, the UE 702 can receive MsgB including the RRC release message and/or the PUR.

In some aspects, a 2-step RACH procedure can be switched to a 4-step RACH procedure. If the random access procedure with a 2-step RA procedure is not completed after a number of MsgA transmissions, e.g., a MsgA transmission maximum (msgA-TransMax), the UE can be configured to switch to a CBRA procedure with a 4-step RA, which can include a Msg1 of a 4-step CBRA procedure. For instance, a UE may select different 4-step RACH preamble groups from the 2-step RACH preamble groups. Also, the transport block (TB) size in the 4-step RACH preamble groups can be larger than the TB size in the 2-step RACH preamble groups. Additionally, the TB size in an UL grant in a Msg2 RAR in the 4-step RACH procedure can be larger than the TB size for a payload transmission in MsgA in the 2-step RACH. In some instances, this can occur if the different 4-step preamble groups are selected when switching to a 4-step RACH.

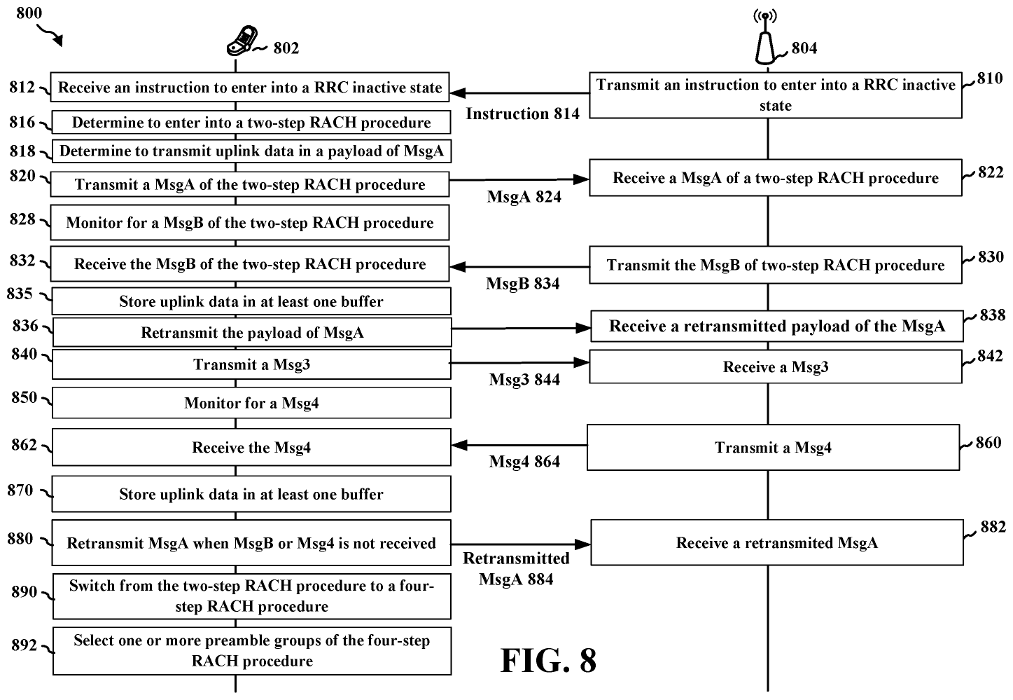

FIG. 8 is a diagram 800 illustrating example communication between a UE 802 and a base station 804.

At 810, base station 804 may transmit, to at least one UE, e.g., UE 802, an instruction to enter into a radio resource control (RRC) inactive state, e.g., instruction 814. At 812, UE 802 may receive an instruction to enter into the RRC inactive state from base station 804, e.g., instruction 814. At 816, UE 802 may determine to enter into a two-step random access channel (RACH) procedure in a radio resource control (RRC) inactive state. At 818, UE 802 may determine to transmit uplink data in a payload of a message A (MsgA) of the two-step RACH procedure.

At 820, UE 802 may transmit the MsgA of the two-step RACH procedure, e.g., MsgA 824, the MsgA including the payload, the payload including at least the uplink data. At 822, base station 804 may receive a message A (MsgA) of a two-step random access channel (RACH) procedure, e.g., MsgA 824, the MsgA including the payload, the payload including at least uplink data. In some aspects, the payload of the MsgA includes at least one of an RRC message or a data request message, the MsgA including a preamble associated with one of one or more preamble groups.

At 828, UE 802 may monitor for a message B (MsgB) of the two-step RACH procedure.

At 830, base station 804 may transmit a message B (MsgB) of the two-step RACH procedure, e.g., MsgB 834. At 832, UE 802 may receive the MsgB of the two-step RACH procedure, e.g., MsgB 834, where the MsgB includes a fallback indication including a fallback random access response (RAR). At 835, UE 802 may store uplink data or a portion of uplink data in at least one buffer. At 836, UE 802 may retransmit the payload of the MsgA when the MsgB including the fallback indication is received. At 838, base station 804 may receive a retransmitted payload of the MsgA when the MsgB including the fallback indication is transmitted.

At 840, UE 802 may transmit a message 3 (Msg3), e.g., Msg3 844, after the MsgB including the fallback indication is received, where a hybrid automatic repeat request (HARQ) retransmission is applied for the Msg3. At 842, base station 804 may receive a message 3 (Msg3), e.g., Msg3 844, after the MsgB including the fallback indication is transmitted, where a hybrid automatic repeat request (HARQ) retransmission is applied for the Msg3. In some aspects, the Msg3 may include a portion of the payload of the MsgA, the portion of the payload of the MsgA corresponding to at least one of an RRC message or at least a portion of the uplink data, wherein the uplink data is user data. The uplink data or a portion of the uplink data may be stored in at least one buffer. Also, the Msg3 may include at least one of an RRC message or a data request message, wherein the data request message is at least one of a medium access control (MAC) control element (MAC-CE) or an RRC message.

At 850, UE 802 may monitor for a message 4 (Msg4) after the Msg3 is transmitted. At 860, base station 804 may transmit a message 4 (Msg4), e.g., Msg4 864, where the Msg4 includes at least one of a preconfigured uplink resource (PUR) or downlink data. At 862, UE 802 may receive the Msg4, e.g., Msg4 864, where the Msg4 includes at least one of a preconfigured uplink resource (PUR) or downlink data.

At 870, UE 802 may store uplink data or a portion of uplink data in at least one buffer, where a payload of a retransmitted MsgA or a retransmitted payload of the MsgA includes at least one of an RRC message or a data request message.

At 880, UE 802 may retransmit the MsgA when the MsgB or a Msg4 is not received, e.g., retransmitted MsgA 884, the retransmitted MsgA including a payload and a preamble, where the retransmitted MsgA includes at least one of an RRC message, a data request message, or at least a portion of the uplink data, where the uplink data is user data. At 882, base station 804 may receive a retransmitted MsgA including a payload and a preamble, e.g., retransmitted MsgA 884, where the retransmitted MsgA includes at least one of an RRC message or a data request message. UE 802 may also select at least one of one or more new preamble groups or a new preamble for the retransmitted MsgA.

At 890, UE 802 may switch from the two-step RACH procedure to a four-step RACH procedure when the MsgA is retransmitted at least a configured threshold number of retransmissions. At 892, UE 802 may select one or more preamble groups of the four-step RACH procedure, where a transport block (TB) size of each of the one or more preamble groups of the four-step RACH procedure is different from a TB size of each of one or more preamble groups of the two-step RACH.

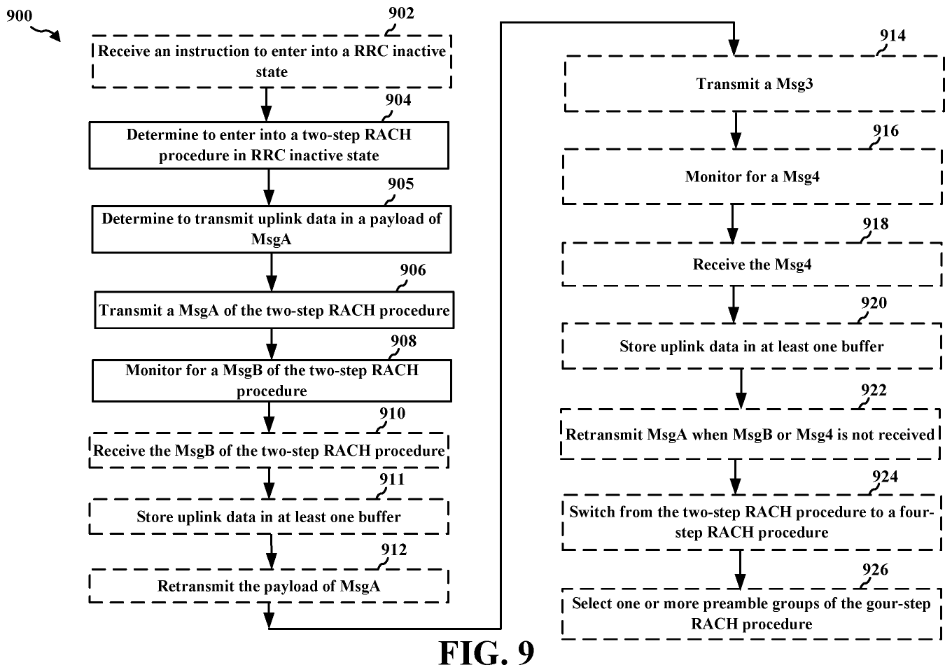

FIG. 9 is a flowchart 900 of a method of wireless communication. The method may be performed by a UE or a component of a UE (e.g., the UE 104, 350, 802; the apparatus 1102; a processing system, which may include the memory 360 and which may be the entire UE or a component of the UE, such as the TX processor 368, the controller/processor 359, transmitter 354TX, antenna(s) 352, and/or the like). Optional aspects are illustrated with a dashed line. The methods described herein can provide a number of benefits, such as improving communication signaling, resource utilization, and/or power savings.

At 902, the apparatus may receive an instruction to enter into the RRC inactive state from a base station, as described in connection with the examples in FIGS. 4, 5, 6, 7, and 8. For example, 902 may be performed by determination component 1140.

At 904, the apparatus may determine to enter into a two-step random access channel (RACH) procedure in a radio resource control (RRC) inactive state, as described in connection with the examples in FIGS. 4, 5, 6, 7, and 8. For example, 904 may be performed by determination component 1140.

At 905, the apparatus may determine to transmit uplink data in a payload of a message A (MsgA) of the two-step RACH procedure, as described in connection with the examples in FIGS. 4, 5, 6, 7, and 8.

At 906, the apparatus may transmit the MsgA of the two-step RACH procedure, the MsgA including the payload, the payload including at least the uplink data, as described in connection with the examples in FIGS. 4, 5, 6, 7, and 8. For example, 906 may be performed by determination component 1140. In some aspects, the payload of the MsgA may include at least one of an RRC message or a data request message, the MsgA including a preamble associated with one of one or more preamble groups, as described in connection with the examples in FIGS. 4, 5, 6, 7, and 8.

At 908, the apparatus may monitor for a message B (MsgB) of the two-step RACH procedure, as described in connection with the examples in FIGS. 4, 5, 6, 7, and 8. For example, 908 may be performed by determination component 1140.

At 910, the apparatus may receive the MsgB of the two-step RACH procedure, where the MsgB includes a fallback indication including a fallback random access response (RAR), as described in connection with the examples in FIGS. 4, 5, 6, 7, and 8. For example, 910 may be performed by determination component 1140. At 911, the apparatus may store uplink data in at least one buffer, as described in connection with the examples in FIGS. 4, 5, 6, 7, and 8.

At 912, the apparatus may retransmit the payload of the MsgA when the MsgB including the fallback indication is received, as described in connection with the examples in FIGS. 4, 5, 6, 7, and 8. For example, 912 may be performed by determination component 1140.

At 914, the apparatus may transmit a message 3 (Msg3) after the MsgB including the fallback indication is received, wherein a hybrid automatic repeat request (HARM) retransmission is applied for the Msg3, as described in connection with the examples in FIGS. 4, 5, 6, 7, and 8. For example, 914 may be performed by determination component 1140.

At 916, the apparatus may monitor for a message 4 (Msg4) after the Msg3 is transmitted, as described in connection with the examples in FIGS. 4, 5, 6, 7, and 8. For example, 916 may be performed by determination component 1140. In some aspects, the Msg3 may include a portion of the payload of the MsgA, the portion of the payload of the MsgA corresponding to at least one of an RRC message or at least a portion of the uplink data, wherein the uplink data is user data, as described in connection with the examples in FIGS. 4, 5, 6, 7, and 8. Also, the Msg3 may include at least one of an RRC message or a data request message, wherein the data request message is at least one of a medium access control (MAC) control element (MAC-CE) or an RRC message, as described in connection with the examples in FIGS. 4, 5, 6, 7, and 8.

At 918, the apparatus may receive the Msg4, where the Msg4 includes at least one of a preconfigured uplink resource (PUR) or downlink data, as described in connection with the examples in FIGS. 4, 5, 6, 7, and 8. For example, 918 may be performed by determination component 1140.

At 920, the apparatus may store uplink data in at least one buffer, where a payload of a retransmitted MsgA or a retransmitted payload of the MsgA includes at least one of an RRC message or a data request message, as described in connection with the examples in FIGS. 4, 5, 6, 7, and 8. For example, 920 may be performed by determination component 1140.

At 922, the apparatus may retransmit the MsgA when the MsgB or a Msg4 is not received, the retransmitted MsgA including a payload and a preamble, wherein the retransmitted MsgA includes at least one of an RRC message, a data request message, or at least a portion of the uplink data, where the uplink data is user data, as described in connection with the examples in FIGS. 4, 5, 6, 7, and 8. For example, 922 may be performed by determination component 1140. Also, the apparatus may select at least one of one or more new preamble groups or a new preamble for the retransmitted MsgA, as described in connection with the examples in FIGS. 4, 5, 6, 7, and 8.

At 924, the apparatus may switch from the two-step RACH procedure to a four-step RACH procedure when the MsgA is retransmitted at least a configured threshold number of retransmissions, as described in connection with the examples in FIGS. 4, 5, 6, 7, and 8. For example, 924 may be performed by determination component 1140.

At 926, the apparatus may select one or more preamble groups of the four-step RACH procedure, where a transport block (TB) size of each of the one or more preamble groups of the four-step RACH procedure is different from a TB size of each of one or more preamble groups of the two-step RACH, as described in connection with the examples in FIGS. 4, 5, 6, 7, and 8. For example, 926 may be performed by determination component 1140.

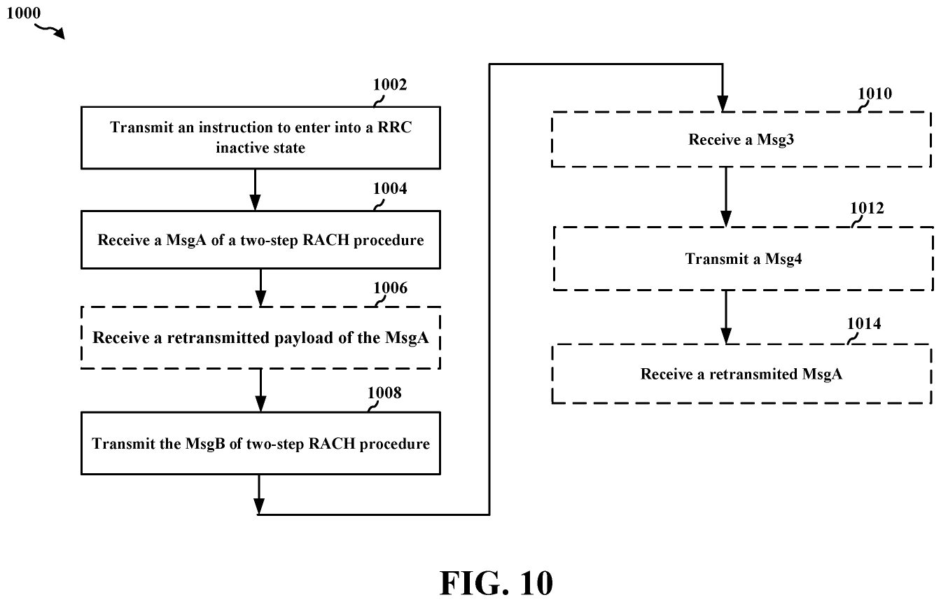

FIG. 10 is a flowchart 1000 of a method of wireless communication. The method may be performed by a base station or a component of a base station (e.g., the base station 102, 180, 310, 804; the apparatus 1202; a processing system, which may include the memory 376 and which may be the entire base station or a component of the base station, such as the antenna(s) 320, receiver 318RX, the RX processor 370, the controller/processor 375, and/or the like). Optional aspects are illustrated with a dashed line. The methods described herein can provide a number of benefits, such as improving communication signaling, resource utilization, and/or power savings.

At 1002, the apparatus may transmit, to at least one UE, an instruction to enter into a radio resource control (RRC) inactive state, as described in connection with the examples in FIGS. 4, 5, 6, 7, and 8. For example, 1002 may be performed by determination component 1240.

At 1004, the apparatus may receive a message A (MsgA) of a two-step random access channel (RACH) procedure, the MsgA including a payload, the payload including at least uplink data, as described in connection with the examples in FIGS. 4, 5, 6, 7, and 8. For example, 1004 may be performed by determination component 1240. In some aspects, the payload of the MsgA may include at least one of an RRC message or a data request message, the MsgA including a preamble associated with one of one or more preamble groups, as described in connection with the examples in FIGS. 4, 5, 6, 7, and 8.

At 1006, the apparatus may receive a retransmitted payload of the MsgA when the MsgB including the fallback indication is transmitted, as described in connection with the examples in FIGS. 4, 5, 6, 7, and 8. For example, 1006 may be performed by determination component 1240.

At 1008, the apparatus may transmit a message B (MsgB) of the two-step RACH procedure, as described in connection with the examples in FIGS. 4, 5, 6, 7, and 8. For example, 1008 may be performed by determination component 1240. In some instances, the MsgB may include a fallback indication including a fallback random access response (RAR), as described in connection with the examples in FIGS. 4, 5, 6, 7, and 8.

At 1010, the apparatus may receive a message 3 (Msg3) after the MsgB including the fallback indication is transmitted, wherein a hybrid automatic repeat request (HARM) retransmission is applied for the Msg3, as described in connection with the examples in FIGS. 4, 5, 6, 7, and 8. For example, 1010 may be performed by determination component 1240. In some aspects, the Msg3 may include a portion of the payload of the MsgA, the portion of the payload of the MsgA corresponding to at least one of an RRC message or at least a portion of the uplink data, where the uplink data is user data, as described in connection with the examples in FIGS. 4, 5, 6, 7, and 8. Also, the Msg3 may include at least one of an RRC message or a data request message, where the data request message is at least one of a medium access control (MAC) control element (MAC-CE) or an RRC message, as described in connection with the examples in FIGS. 4, 5, 6, 7, and 8.

At 1012, the apparatus may transmit a message 4 (Msg4), where the Msg4 includes at least one of a preconfigured uplink resource (PUR) or downlink data, as described in connection with the examples in FIGS. 4, 5, 6, 7, and 8. For example, 1012 may be performed by determination component 1240.

At 1014, the apparatus may receive a retransmitted MsgA including a payload and a preamble, where the retransmitted MsgA includes at least one of an RRC message, a data request message, or at least a portion of the uplink data, where the uplink data is user data, as described in connection with the examples in FIGS. 4, 5, 6, 7, and 8. For example, 1014 may be performed by determination component 1240. In some aspects, the retransmitted MsgA may include at least one of one or more new preamble groups or a new preamble, as described in connection with the examples in FIGS. 4, 5, 6, 7, and 8. Further, a payload of a retransmitted MsgA or a retransmitted payload of the MsgA may include at least one of an RRC message or a data request message, as described in connection with the examples in FIGS. 4, 5, 6, 7, and 8. Additionally, the two-step RACH procedure may be switched to a four-step RACH procedure when the retransmitted MsgA is received, as described in connection with the examples in FIGS. 4, 5, 6, 7, and 8. Moreover, the four-step RACH procedure may include one or more preamble groups, where a transport block (TB) size of each of the one or more preamble groups of the four-step RACH procedure is different from a TB size of each of one or more preamble groups of the two-step RACH, as described in connection with the examples in FIGS. 4, 5, 6, 7, and 8.

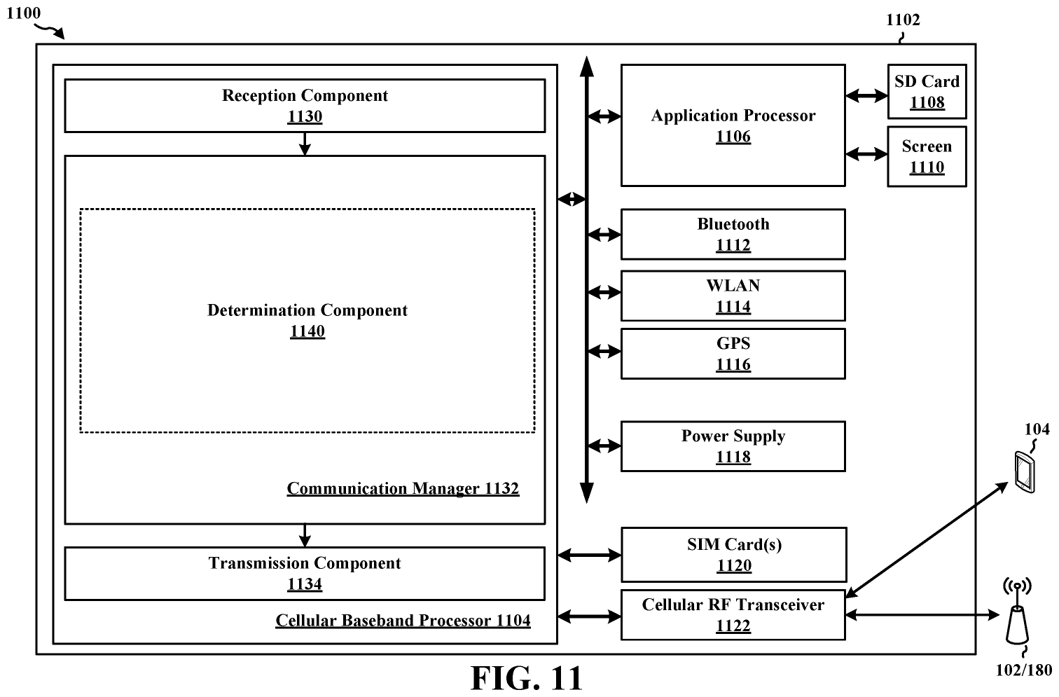

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the aforediscussed additional modules of the apparatus 1102.

The communication manager 1132 includes a determination component 1140 that is configured to determine to enter into a two-step random access channel (RACH) procedure in a radio resource control (RRC) inactive state, e.g., as described in connection with step 904 above. Determination component 1140 can also be configured to determine to transmit uplink data in a payload of a message A (MsgA) of the two-step RACH procedure, e.g., as described in connection with step 905 above. Determination component 1140 can also be configured to transmit the MsgA of the two-step RACH procedure, the MsgA including the payload, the payload including at least the uplink data, e.g., as described in connection with step 906 above. Determination component 1140 can also be configured to monitor for a message B (MsgB) of the two-step RACH procedure, e.g., as described in connection with step 908 above.

The apparatus may include additional components that perform each of the blocks of the algorithm in the aforementioned flowcharts of FIGS. 8 and 9. As such, each block in the aforementioned flowcharts of FIGS. 8 and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for determining to enter into a two-step random access channel (RACH) procedure in a radio resource control (RRC) inactive state. The apparatus 1102 can also include means for determining to transmit uplink data in a payload of a message A (MsgA) of the two-step RACH procedure. The apparatus 1102 can also include means for transmitting the MsgA of the two-step RACH procedure, the MsgA including the payload, the payload including at least the uplink data. The apparatus 1102 can also include means for monitoring for a message B (MsgB) of the two-step RACH procedure. The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

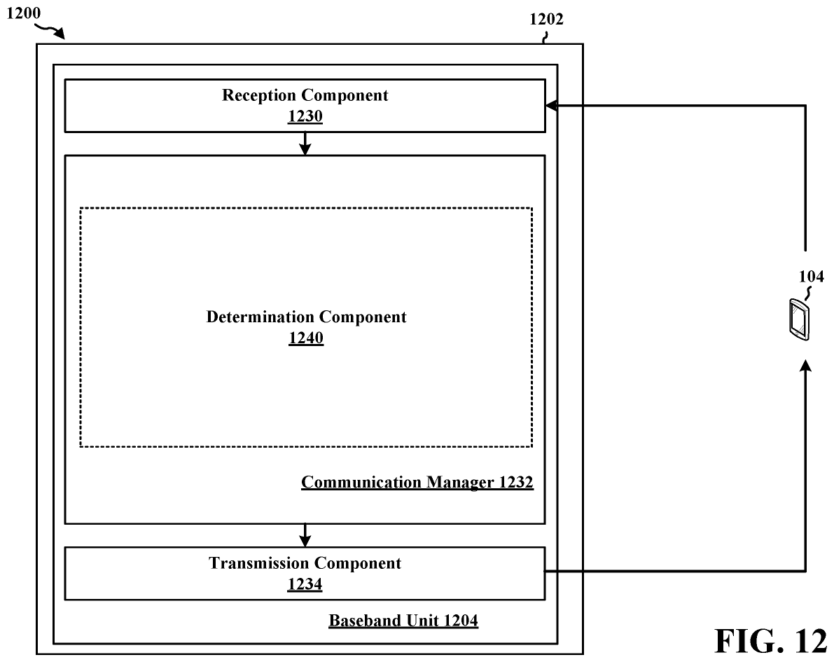

FIG. 12 is a diagram 1200 illustrating an example of a hardware implementation for an apparatus 1202. The apparatus 1202 is a base station and includes a baseband unit 1204. The baseband unit 1204 may communicate through a cellular RF transceiver with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the BS 310 and may include the memory 376 and/or at least one of the TX processor 316, the RX processor 370, and the controller/processor 375.

The communication manager 1232 includes a determination component 1240 that is configured to transmit, to at least one UE, an instruction to enter into a radio resource control (RRC) inactive state, e.g., as described in connection with step 1002 above. Determination component 1240 can also be configured to receive a message A (MsgA) of a two-step random access channel (RACH) procedure, the MsgA including a payload, the payload including at least uplink data, e.g., as described in connection with step 1004 above. Determination component 1240 can also be configured to transmit a message B (MsgB) of the two-step RACH procedure, e.g., as described in connection with step 1008 above.

The apparatus may include additional components that perform each of the blocks of the algorithm in the aforementioned flowcharts of FIGS. 8 and 10. As such, each block in the aforementioned flowcharts of FIGS. 8 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for transmitting, to at least one user equipment (UE), an instruction to enter into a radio resource control (RRC) inactive state. The apparatus 1202 can also include means for receiving a message A (MsgA) of a two-step random access channel (RACH) procedure, the MsgA including a payload, the payload including at least uplink data. The apparatus 1202 can also include means for transmitting a message B (MsgB) of the two-step RACH procedure. The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Further disclosure is included in the Appendix.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An apparatus for wireless communication at a user equipment (UE), comprising:
a memory; and
at least one processor coupled to the memory and configured to:
determine to enter into a two-step random access channel (RACH) procedure in a radio resource control (RRC) inactive state;
determine to transmit uplink data in a payload of a message A (MsgA) of the two-step RACH procedure;
transmit the MsgA of the two-step RACH procedure, the MsgA including the payload, the payload including at least the uplink data; and
monitor for a message B (MsgB) of the two-step RACH procedure.

2. The apparatus of claim 1, wherein the payload of the MsgA includes at least one of an RRC message or a data request message, the MsgA including a preamble associated with one of one or more preamble groups.

3. The apparatus of claim 1, wherein the at least one processor is further configured to:
receive the MsgB of the two-step RACH procedure, wherein the MsgB includes a fallback indication including a fallback random access response (RAR).

4. The apparatus of claim 3, wherein the at least one processor is further configured to:
retransmit the payload of the MsgA when the MsgB including the fallback indication is received.

5. The apparatus of claim 3, wherein the at least one processor is further configured to:
transmit a message 3 (Msg3) after the MsgB including the fallback indication is received, wherein a hybrid automatic repeat request (HARM) retransmission is applied for the Msg3.

6. The apparatus of claim 5, wherein the Msg3 includes a portion of the payload of the MsgA, the portion of the payload of the MsgA corresponding to at least one of an RRC message or at least a portion of the uplink data, wherein the uplink data is user data.

7. The apparatus of claim 5, wherein the Msg3 includes at least one of an RRC message or a data request message, wherein the data request message is at least one of a medium access control (MAC) control element (MAC-CE) or an RRC message.

8. The apparatus of claim 5, wherein the at least one processor is further configured to:
monitor for a message 4 (Msg4) after the Msg3 is transmitted.

9. The apparatus of claim 8, wherein the at least one processor is further configured to:
receive the Msg4, wherein the Msg4 includes at least one of a preconfigured uplink resource (PUR) or downlink data.

10. The apparatus of claim 1, wherein the at least one processor is further configured to:
retransmit the MsgA when the MsgB or a Msg4 is not received, the retransmitted MsgA including a payload and a preamble, wherein the retransmitted MsgA includes at least one of an RRC message or a data request message.

11. The apparatus of claim 10, wherein the at least one processor is further configured to:
select at least one of one or more new preamble groups or a new preamble for the retransmitted MsgA.

12. The apparatus of claim 10, wherein the at least one processor is further configured to:
switch from the two-step RACH procedure to a four-step RACH procedure when the MsgA is retransmitted at least a configured threshold number of retransmissions.

13. The apparatus of claim 12, wherein the at least one processor is further configured to:
select one or more preamble groups of the four-step RACH procedure, wherein a transport block (TB) size of each of the one or more preamble groups of the four-step RACH procedure is different from a TB size of each of one or more preamble groups of the two-step RACH.

14. The apparatus of claim 1, wherein the at least one processor is further configured to:
store the uplink data in at least one buffer, wherein a payload of a retransmitted MsgA or a retransmitted payload of the MsgA includes at least one of an RRC message or a data request message.

15. The apparatus of claim 1, wherein the at least one processor is further configured to:
receive an instruction to enter into the RRC inactive state from a base station.

16. A method of wireless communication at a user equipment (UE), comprising:
determining to enter into a two-step random access channel (RACH) procedure in a radio resource control (RRC) inactive state;
determining to transmit uplink data in a payload of a message A (MsgA) of the two-step RACH procedure;
transmitting the MsgA of the two-step RACH procedure, the MsgA including the payload, the payload including at least the uplink data; and
monitoring for a message B (MsgB) of the two-step RACH procedure.

17. The method of claim 16, wherein the payload of the MsgA includes at least one of an RRC message or a data request message, the MsgA including a preamble associated with one of one or more preamble groups.

18. The method of claim 16, further comprising:
receiving the MsgB of the two-step RACH procedure, wherein the MsgB includes a fallback indication including a fallback random access response (RAR).

19. The method of claim 18, further comprising:
retransmitting the payload of the MsgA when the MsgB including the fallback indication is received.

20. The method of claim 18, further comprising:
transmitting a message 3 (Msg3) after the MsgB including the fallback indication is received, wherein a hybrid automatic repeat request (HARM) retransmission is applied for the Msg3.

21. An apparatus for wireless communication of a user equipment (UE), comprising:
means for determining to enter into a two-step random access channel (RACH) procedure in a radio resource control (RRC) inactive state;
means for determining to transmit uplink data in a payload of a message A (MsgA) of the two-step RACH procedure;
means for transmitting the MsgA of the two-step RACH procedure, the MsgA including the payload, the payload including at least the uplink data; and
means for monitoring for a message B (MsgB) of the two-step RACH procedure.

22. An apparatus for wireless communication at a base station, comprising:
a memory; and
at least one processor coupled to the memory and configured to:
transmit, to at least one user equipment (UE), an instruction to enter into a radio resource control (RRC) inactive state;
receive a message A (MsgA) of a two-step random access channel (RACH) procedure, the MsgA including a payload, the payload including at least uplink data; and
transmit a message B (MsgB) of the two-step RACH procedure.

23. The apparatus of claim 22, wherein the payload of the MsgA includes at least one of an RRC message or a data request message, the MsgA including a preamble associated with one of one or more preamble groups.

24. The apparatus of claim 22, wherein the MsgB includes a fallback indication including a fallback random access response (RAR).

25. The apparatus of claim 24, wherein the at least one processor is further configured to:
receive a retransmitted payload of the MsgA when the MsgB including the fallback indication is transmitted.

26. The apparatus of claim 24, wherein the at least one processor is further configured to:
receive a message 3 (Msg3) after the MsgB including the fallback indication is transmitted, wherein a hybrid automatic repeat request (HARM) retransmission is applied for the Msg3.

27. The apparatus of claim 26, wherein the Msg3 includes a portion of the payload of the MsgA, the portion of the payload of the MsgA corresponding to at least one of an RRC message or at least a portion of the uplink data, wherein the uplink data is user data.

28. The apparatus of claim 26, wherein the Msg3 includes at least one of an RRC message or a data request message, wherein the data request message is at least one of a medium access control (MAC) control element (MAC-CE) or an RRC message.

29. The apparatus of claim 22, wherein the at least one processor is further configured to:
transmit a message 4 (Msg4), wherein the Msg4 includes at least one of a preconfigured uplink resource (PUR) or downlink data.

30. The apparatus of claim 22, wherein the at least one processor is further configured to:
receive a retransmitted MsgA including a payload and a preamble, wherein the retransmitted MsgA includes at least one of an RRC message or a data request message.

31. The apparatus of claim 30, wherein the retransmitted MsgA includes at least one of one or more new preamble groups or a new preamble.

32. The apparatus of claim 30, wherein the two-step RACH procedure is switched to a four-step RACH procedure when the retransmitted MsgA is received.

33. The apparatus of claim 32, wherein the four-step RACH procedure includes one or more preamble groups, wherein a transport block (TB) size of each of the one or more preamble groups of the four-step RACH procedure is different from a TB size of each of one or more preamble groups of the two-step RACH.

34. The apparatus of claim 22, wherein a payload of a retransmitted MsgA or a retransmitted payload of the MsgA includes at least one of an RRC message or a data request message.

35. A method of wireless communication at a base station, comprising:
transmitting, to at least one user equipment (UE), an instruction to enter into a radio resource control (RRC) inactive state;
receiving a message A (MsgA) of a two-step random access channel (RACH) procedure, the MsgA including a payload, the payload including at least uplink data; and
transmitting a message B (MsgB) of the two-step RACH procedure.
